(19) United States
(12) Patent Application Publication
(10) Pub. No.: US 2025/0229861 A1
(43) Pub. Date: Jul. 17, 2025

(54) Bicycle Rim

(71) Applicant: Canyon Bicycles GmbH, Koblenz (DE)

(72) Inventors: Caspar Rüter, Köln (DE); Mazen Jrab, Frankfurt (DE); Kyle Debelak, Stuttgart (DE)

(21) Appl. No.: 19/022,637

(22) Filed: Jan. 15, 2025

(30) Foreign Application Priority Data
Jan. 16, 2024 (DE) 20 2024 100 187.7

(51) Int. Cl. B62J 45/41; B60B 21/12; B60C 23/00; B60C 23/04

(52) U.S. Cl. CPC B62J 45/41; B60B 21/12; B60C 23/006; B60C 23/0427; B60C 23/0494

(57) ABSTRACT

A bicycle rim includes a rim well which is connected to rim walls. A pressure sensor is connected to the rim well. The pressure sensor is electrically connected to an NFC antenna for contactless transmission of data and contactless reception of energy.

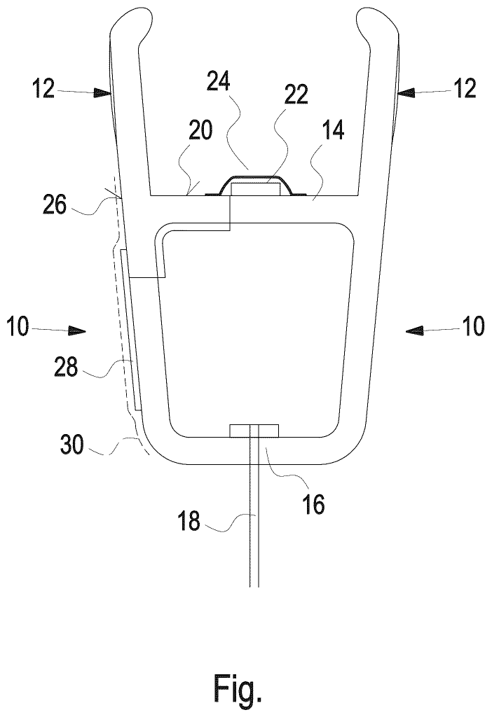

### CROSS-REFERENCE TO RELATED APPLICATION

This application claims priority to German Patent Application No. 20 2024 100 187.7 filed Jan. 16, 2024, the disclosure of which is hereby incorporated by reference in its entirety.

### BACKGROUND OF THE INVENTION

### Field of the Invention

The invention relates to a bicycle rim.

### Description of Related Art

In order to measure the pressure in a bicycle tire, i.e. in a tubeless casing or in a tube arranged inside a casing, it is known, for example, to connect a corresponding pressure sensor to the valve. This requires the pressure sensor to be screwed onto the valve via a tube, for example, so that the pressure can then be read on a pressure gauge or the like. Furthermore, such a device has the disadvantage that it must also be carried by the user in order to be able to measure the tire pressure on a longer bicycle tour, for example. Furthermore, the company Tubolito is known to produce a tube for a bicycle tire in which a pressure sensor is integrated. The pressure sensor is connected to an NFC antenna so that the pressure can be transmitted in a contactless manner to an external receiving device, such as a cell phone, via the NFC antenna. However, this system has the disadvantage that a bicycle tube is a spare part, which means that the pressure sensor and the NFC antenna always have to be replaced along with the tube. In this respect, this product is expensive and unsustainable. Furthermore, it is a tube system, which is therefore not suitable for modern tubeless tires.

### SUMMARY OF THE INVENTION

The object of the invention is to improve the pressure measurement of bicycle tires. According to the invention, the object is achieved with a bicycle rim with a pressure sensor having features as described herein.

The bicycle rim according to the invention comprises, in accordance with a conventional rim, a rim well and rim walls connected to the rim well. The rim walls also form the rim flanges or merge into the rim flanges, which are then used to receive the bicycle casing. This can be a rim and a bicycle casing, which can be operated in a tubeless manner due to their configuration. Furthermore, a bicycle tube can also be arranged inside the bicycle casing.

Moreover, a pressure sensor for measuring a pressure prevailing inside a bicycle tire is also provided. Here, the pressure sensor is suitable for measuring the pressure in a tubeless tire as well as in a tire provided with a bicycle tube. A transmitting unit is electrically connected to the pressure sensor. The transmitting unit itself is in particular an NFC antenna or another transmitting device that can communicate with an external device, in particular with a cell phone, or can transmit the measured pressure data to the external device, respectively. Furthermore, a receiving unit is electrically connected to the pressure sensor. The receiving unit is used for contactless reception of energy and then transmits this energy to the pressure sensor. In particular, the energy transfer is performed inductively.

Preferably, the NFC antenna is a passive component that is used to transmit and receive electromagnetic energy. In a preferred embodiment, an electronic component is connected to the pressure sensor. This component preferably comprises an NFC transmitter and an NFC receiver. It is particularly preferred that the pressure sensor and the electronic component are combined in a single component or are formed as an integrated component, respectively.

Since the pressure sensor according to the invention is connected to the rim, in particular the rim well, or is integrated into components of the rim, it is possible to use the pressure sensor for tubeless tires as well as for tubular tires. Replacing a tube does not involve replacing the pressure sensor or the components connected to the pressure sensor, such as the transmitting device and the receiving device, making it a cost-effective and sustainable device for measuring the pressure of bicycle tires.

Preferably, the pressure sensor is located on an inner side of the rim well. The inner side of the rim well is the side facing away from the hub, i.e. the side on which the tire, i.e. the casing and a tube that may be provided, is arranged.

It is particularly preferred that the pressure sensor is at least partially integrated into the rim well. This ensures reliable fixing of the pressure sensor. In the case of rims made of a plastic material such as carbon, the pressure sensor can be partially integrated into the rim well during production so that in particular only the area absorbing the pressure is exposed such that pressure measurement is reliably possible.

The antenna of the transmitting device and/or the receiving device are preferably arranged on an outer side of one of the rim walls. This ensures reliable transmission of the measured pressure data and reliable reception of energy. In a preferred further embodiment of the invention, such a transmitting and/or receiving device is covered by a protective layer and, in a particularly preferred embodiment, is integrated into one of the rim walls. This is already possible during production, particularly in the case of a rim made from a plastic material such as carbon. Thus, the transmitting and/or receiving device, i.e. the NFC antenna in particular, is protected.

The pressure sensor, which is preferably formed together with the NFC transmitter and the NFC receiver as a common component, is electrically connected to the transmitting unit and/or receiving unit, in particular the NFC antenna. This connection can be made via electrical cables. An electrical connection via a valve stem is also possible. This is particularly expedient for tubeless tires, as the valve of tubeless tires does not need to be replaced, or only rarely. Using the valve stem for the electrical connection has the advantage that no cables need to be laid. Alternatively, an electrical connection is also possible by providing conductive layers, which are printed on in particular.

In a preferred further development of the invention, the pressure sensor is provided with a protective cap. The protective cap ensures reliable pressure measurement. On the one hand, this is ensured in such a way that the protective cap prevents contamination of the pressure sensor by the sealant in tubeless tires. On the other hand, the protective cap makes it possible for it to rest against a bicycle tube and for pressure to be reliably transmitted to the pressure sensor via the protective cap. This has the advantage that a pressure sensor further developed in accordance with the invention can be used for tubeless tires as well as for tubular tires.

A particular advantage of the invention is also that the possibility of energy transfer means that it is not necessary to provide a battery. In this respect, no elaborate replacement of batteries is necessary.

In the following, the invention is described in more detail by means of a preferred embodiment with reference to the accompanying drawing.

### BRIEF DESCRIPTION OF THE DRAWINGS

The terms Fig., Figs., Figure, and Figures are used interchangeably in the specification to refer to the corresponding figures in the drawings.

The FIGURE shows a schematic cross-section of a preferred embodiment of a bicycle rim according to the invention.

### DESCRIPTION OF THE INVENTION

The bicycle rim has opposing rim walls 10 that merge into rim flanges 12. A rim well 14 is arranged between the rim flanges 12. In the FIGURE, the bicycle tire is arranged above rim well 14 in the mounted state, wherein a bicycle casing is held by the rim flanges 12 and a bicycle tube can be arranged inside the bicycle casing. A tubeless tire does not have a tube inside the bicycle casing.

A connecting element 16 connecting the side walls 10 is arranged on an opposite side of the rim in relation to rim well 14, wherein it is particularly preferred that the side walls 10, the rim flanges 12, rim well 14 and also connecting element 16 are integrally formed. In the illustrated exemplary embodiment, spokes 18 are connected to connecting element 16.

A pressure sensor 22, which is covered by a protective cap 24, is arranged on an inner side 20 of rim well 14. Pressure sensor 22 is preferably formed together with an NFC transmitter and an NFC receiver as a single component.

An NFC antenna 28 is arranged as a transmitting unit and receiving unit on an outer side 26 of the left-hand rim wall 10 shown in the FIGURE. Preferably, the NFC antenna is a passive component for transmitting and receiving electromagnetic energy. In the illustrated embodiment example, NFC antenna 28 is protected by a protective layer or protective film 30 shown as a dashed line. Alternatively, the NFC antenna could also be arranged inside rim wall 10.

In the illustrated exemplary embodiment, cables 32 are provided for the electrical connection of NFC antenna 28 to pressure sensor 22.

1. A bicycle rim comprising
a rim well,
two rim walls connected to the rim well,
a pressure sensor for measuring a pressure prevailing inside a bicycle tire,
a transmitting device electrically connected to the pressure sensor, and
a receiving device electrically connected to the pressure sensor for contactless reception of energy.

2. The bicycle rim according to claim 1, wherein the pressure sensor is arranged on an inner side of the rim well.

3. The bicycle rim according to claim 1, wherein the pressure sensor is at least partially integrated into the rim well.

4. The bicycle rim according to claim 1, wherein the transmitting device comprises an NFC antenna, is preferably configured as an NFC antenna.

5. The bicycle rim according to claim 1, wherein the receiving device is integrated into the transmitting device.

6. The bicycle rim according to claim 1, wherein the transmitting device and/or the receiving device is arranged on an outer side of one of the rim walls.

7. The bicycle rim according to claim 6, wherein the transmitting device and/or the receiving device is covered with a protective layer.

8. The bicycle rim according to claim 1, wherein the transmitting device and/or the receiving device is at least partially integrated into one of the rim walls.

9. The bicycle rim according to claim 1, wherein the pressure sensor is electrically connected to the transmitting device and/or the receiving device via cables and/or via a valve stem and/or conductive layers.

10. The bicycle rim according to claim 1, wherein the pressure sensor is protected by a protective cap.

11. The bicycle rim according to claim 10, wherein the protective cap is suitable for pressure transmission.
